(19) United States
(12) Patent Application Publication
(10) Pub. No.: US 2025/0283777 A1
(43) Pub. Date: Sep. 11, 2025

(54) SHAKER FIXING DEVICE AND SHAKER SYSTEM

(71) Applicant: NIPPON TELEGRAPH AND TELEPHONE CORPORATION, Tokyo (JP)

(72) Inventors: Daiki KOBAYASHI, Tokyo (JP); Toshiki NAKANISHI, Tokyo (JP); Yosuke SAKURADA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/855,738

(22) PCT Filed: Apr. 14, 2022
(86) PCT No.: PCT/JP2022/017865

§ 371 Date: Oct. 10, 2024

(51) Int. Cl. G01M 7/02

(52) U.S. Cl. CPC G01M 7/02

(57) ABSTRACT

A fixing device (1) according to the present disclosure includes: a base (11); a first shaft member (12) that is provided on the base (11) and extends in a first direction; and a second shaft member (13) that is attached to the first shaft member (12), extends in a second direction orthogonal to the first direction, is movable in the first direction and the second direction with respect to the first shaft member (12), and to which a vibrator (2) is attached.

### TECHNICAL FIELD

The present invention relates to a fixing device for a vibrator and a vibrating system.

### BACKGROUND ART

In constructing a structure, it is known to measure a natural frequency or the like of the structure through model testing so that resonance does not occur in the structure (see Non Patent Literature 1). Modal testing according to the simplest and most general method is performed by using an impulse hammer and an accelerometer.

Since the impulse hammer applies vibration to a structure by human power, when a large structure such as a bridge receives application of vibration from an impulse hammer, the excitation force is significantly attenuated, and the resonance frequency may not be measured with desired accuracy. On the other hand, a general vibrator used in modal testing can generate vibration with a magnitude sufficient to measure a resonance frequency of a large structure with desired accuracy.

For example, Non Patent Literature 2 describes a vibrator that is installed on a side of an automobile by being attached to a fixing device and vibrates the automobile from the side. Furthermore, Non Patent Literature 3 describes a vibrator that is installed on the ground and vibrates wings of an unmanned aerial vehicle (UAV) upward from below.

### CITATION LIST

### Non Patent Literature

Non Patent Literature 1: Gakuho Watanabe, and three others, “Health monitoring and identification of dynamic characteristics of a skewed bridge based on the vibration test using a moving vehicle”, The Japan Society of Civil Engineers, Journal of Structural Engineering, Vol. 60A, March 2014
Non Patent Literature 2: “MD-0348-revA (Modal Analysis Testing with Large Channel Systems Diagram-NVH)-1021”, [online], [Retrieved on Apr. 1, 2022], the Internet <URL: https://www.pcb.com/contentstore/MktgContent/LinkedDocument s/AutomotiveSensors/ModalAnalysisDiagram-NVH2. pdf>
Non Patent Literature 3: “Application rei kashinki|Toyo technica|“hakaru” gijutsude miraio tsukuru|kikai seigyo/shindo soon (in Japanese) (Application Example Vibrator|TOYO Corporation|Creating the future with “MEASURING” technology|Mechanical control/vibration noise) “, [online], [Retrieved on 1, 2022], the Internet <URL: https://www.toyo.co.jp/mecha/contents/detail/id=20272>

### Summary of Invention

### Technical Problem

However, the fixing device described in Non Patent Literature 2 can move the vibrator in the vertical direction to vibrate the object from the side, but cannot vibrate the object from above and below. In addition, the vibrator of Non Patent Literature 3 can vibrate an object from below, but cannot vibrate an object from above or cannot vibrate an object from a side.

On the other hand, in a vibration characteristics test of an attachment pipe provided on a large structure such as a bridge, it is required to measure a response to a vibration imitating a vibration caused by a vehicle passing through the large structure. In addition, the attachment pipes are provided on various sides (upper side, lower side, left side, right side, etc.) at various positions in the large structure. As an example, attachment pipes may be provided under a bridge by using bridge beams for a bridge that is a large structure. Therefore, in vibration characteristics tests, a vibrator is desirably installed to be able to vibrate a structure in both the vertical direction and the horizontal direction at various positions.

### Solution to Problem

In order to solve the above-described problem, a fixing device according to the present disclosure includes a base, a first shaft member provided on the base and extending in a first direction, and a second shaft member that is attached to the first shaft member, extends in a second direction orthogonal to the first direction, and is movable in the first direction and the second direction with respect to the first shaft member, and to which the vibrator is attached.

In addition, in order to solve the above-described problem, a vibrating system according to the present disclosure is a vibrating system including a fixing device and
a vibrator attached to the fixing device, in which the fixing device includes a base, a first shaft member provided on the base and extending in the first direction, and a second shaft member that is attached to the first shaft member, extends in a second direction orthogonal to the first direction, and is movable in the first direction and the second direction with respect to the first shaft member, and to which the vibrator is attached.

### Advantageous Effects of Invention

According to the present invention, a fixing device and a vibrating system capable of installing a vibrator to vibrate a structure in both the vertical direction and the horizontal direction at various positions are provided.

### BRIEF DESCRIPTION OF DRAWINGS

FIG. 1 is a perspective diagram illustrating an example of a vibrating system according to a first embodiment.

FIG. 2 is a perspective diagram of the vibrating system in a state that the second shaft member illustrated in FIG. 1 has moved in the horizontal direction.

FIG. 3 is a perspective diagram of the vibrating system in a state that the second shaft member illustrated in FIG. 1 has moved in the vertical direction.

FIG. 4 is a perspective diagram of the vibrating system in a state that the second shaft member illustrated in FIG. 1 has moved in the horizontal direction and the vertical direction.

FIG. 5 is a diagram illustrating the vibrator illustrated in FIG. 1 in detail.

FIG. 6 is a perspective view illustrating an aspect in which the vibrator illustrated in FIG. 1 is oriented in a different direction.

FIG. 7 is a perspective view illustrating an example in which the vibrator illustrated in FIG. 1 is attached to a fixing device using a different method.

FIG. 8A is a perspective view of an attachment pipe which is an example of an object to be vibrated by the vibrator.

FIG. 8B is a cross-sectional view taken along line A-A in FIG. 8A.

FIG. 9 is a perspective diagram illustrating an example of a vibrating system according to a second embodiment.

FIG. 10 is a perspective view illustrating a state in which the vibrating system illustrated in FIG. 9 is installed to vibrate an attachment pipe.

### Description of Embodiments

### First Embodiment

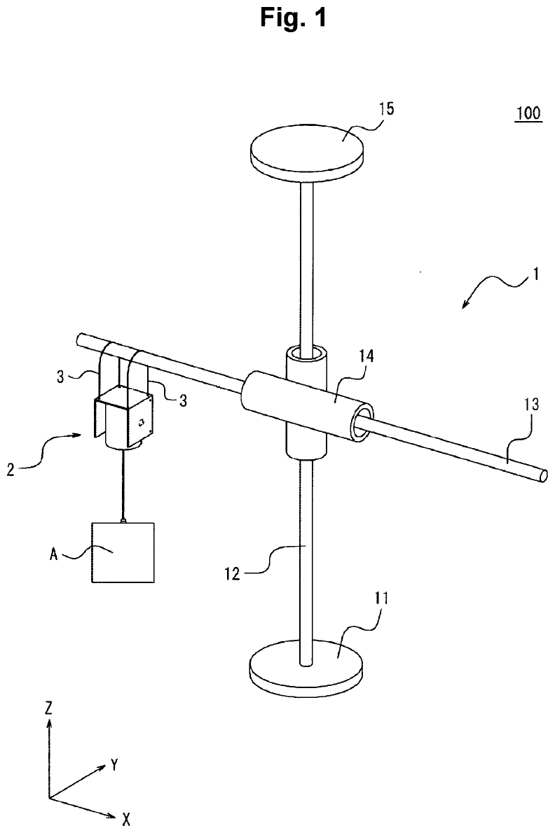

An overall configuration of a first embodiment will be described with reference to FIG. 1. FIG. 1 is a schematic diagram of a vibrating system 100 according to the present embodiment.

As illustrated in FIG. 1, the vibrating system 100 according to the first embodiment includes a fixing device 1, a vibrator 2, and attachment members 3.

### Configuration of Fixing Device

The fixing device 1 includes a base 11, a first shaft member 12, a second shaft member 13, and a shaft fixing portion 14. The fixing device 1 may further include a top board 15.

The base 11 is a base on which the first shaft member 12 is provided. The base 11 may have a flat surface. In the example illustrated in FIG. 1, the base 11 is a flat plate-shaped member having two circular surfaces facing opposite to each other. The shape of the surfaces of the base 11 may be any shape such as a polygon or an ellipse. The base 11 is stably installed by being arranged such that a plane of the base 11 is in contact with the ground.

The first shaft member 12 is a member provided on the base 11 and extending in a first direction. In the configuration in which the base 11 has at least one plane, the first shaft member 12 extends in a direction orthogonal to the one plane of the base 11 (the plane on the side in contact with the ground when the fixing device 1 is used) on the side opposite to the plane. As a result, in a state in which the base 11 is installed with one plane of the base 11 in contact with the ground, the first direction is the vertical direction (the Z-axis direction in FIG. 1). Furthermore, the first shaft member 12 may be configured integrally with the base 11, or may be configured separately from the base 11 and attached to the base 11.

The second shaft member 13 is attached to the first shaft member 12 and extends in a second direction orthogonal to the first direction. For this reason, when the first direction is the vertical direction (the Z-axis direction in FIG. 1) as described above, the second direction is the horizontal direction (the X-axis direction in FIG. 1). In addition, the vibrator 2 is attached to the second shaft member 13.

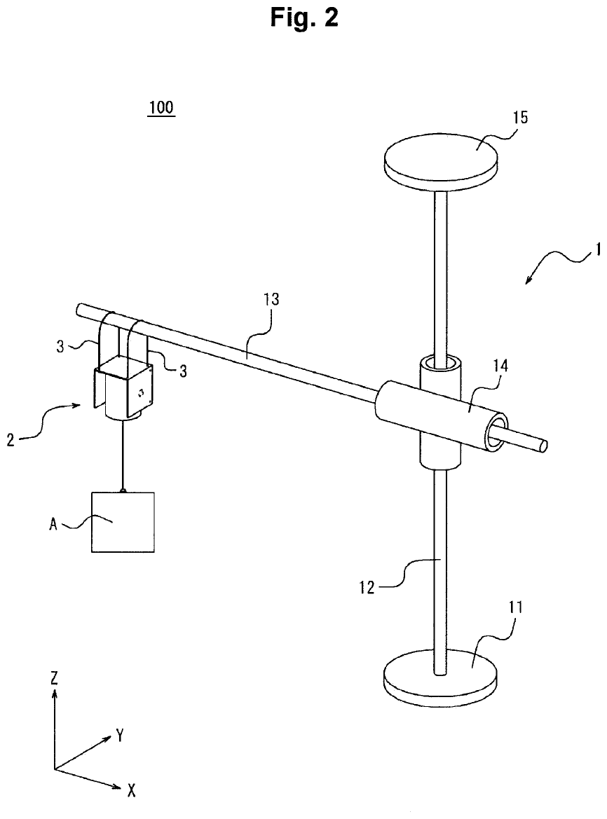

The second shaft member 13 is movable in the second direction (the X-axis direction in FIG. 1) relative to the first shaft member 12. The second shaft member 13 may be disposed not to be in contact with the first shaft member 12, and is fixed to the first shaft member 12 by the shaft fixing portion 14 at any position along the first shaft member 12. The second shaft member 13 may be fixed to the first shaft member 12 by the shaft fixing portion 14 such that the length from the intersection portion to the end portion is a desired length. The intersection portion is a portion of the second shaft member 13 attached to the first shaft member 12. For example, when the second shaft member 13 moves in the second direction (the negative direction of the X axis in FIG. 1) from the state illustrated in FIG. 1, the portion of the second shaft member 13 located on one side (the negative direction side of the X axis in the example of FIG. 2) from the first shaft member 12 is longer than the portion of the second shaft member 13 located on the other side (the positive direction side of the X axis in the example of FIG. 2) from the first shaft member 12 as illustrated in FIG. 2.

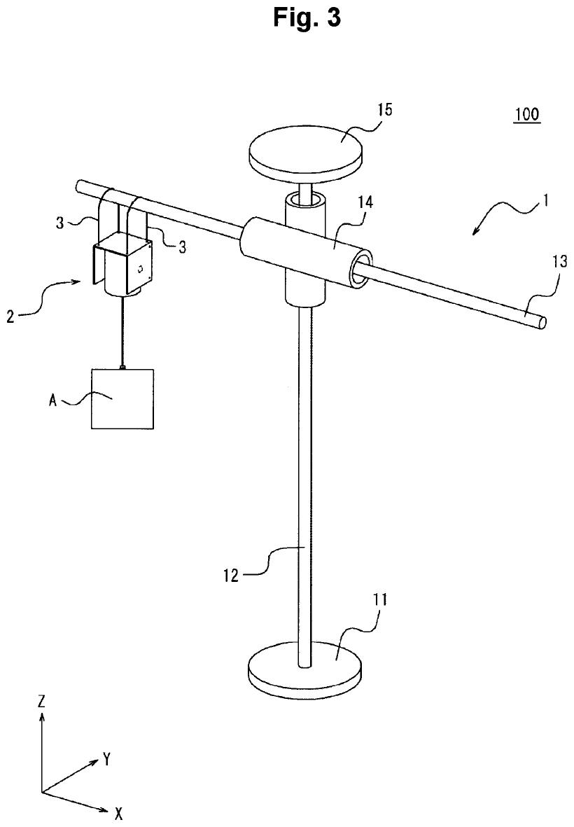

In addition, the second shaft member 13 is movable in the first direction (the Z-axis direction in FIG. 3) relative to the first shaft member 12 as illustrated in FIG. 3. The second shaft member 13 may be attached to the first shaft member 12 such that the length from the intersection portion with respect to the first shaft member 12 to an end portion thereof is a desired length. For example, when the second shaft member 13 moves in the first direction (the positive direction of the Z axis in FIG. 1) from the state illustrated in FIG. 1, the portion of the first shaft member 12 located on one side (the negative direction side of the Z axis in FIG. 3) from the second shaft member 13 is longer than the portion of the first shaft member 12 located on the other side (the positive direction side of the Z axis in the example of FIG. 3) from the second shaft member 13 as illustrated in FIG. 3.

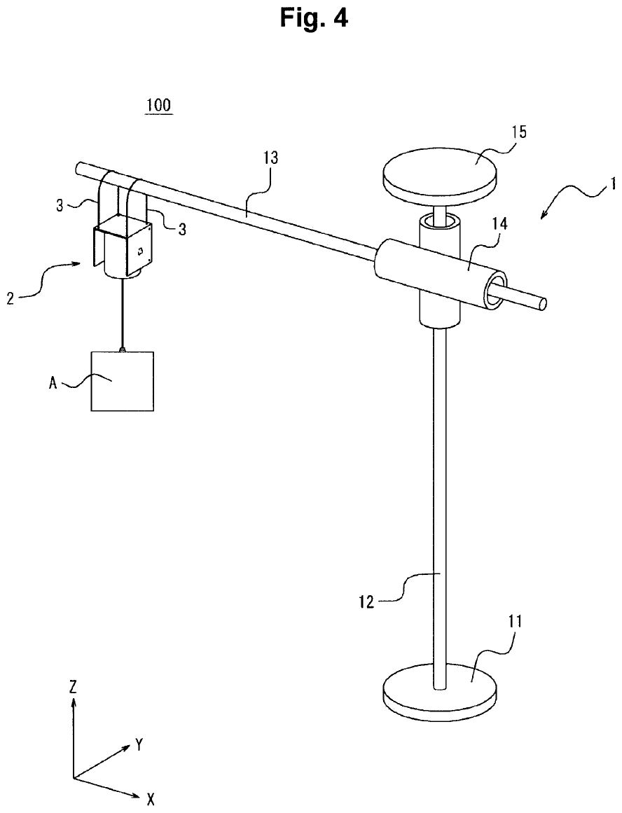

In this manner, the second shaft member 13 is movable in the first direction and the second direction relative to the first shaft member 12. When the second shaft member 13 moves in the first direction (Z-axis direction) and the second direction (X-axis direction) from the state illustrated in FIG. 1, the portion of the second shaft member 13 located on one side (the negative direction side of the X axis in the example of FIG. 4) from the first shaft member 12 is longer than the portion of the second shaft member 13 located on the other side (the positive direction side of the X axis in the example of FIG. 4) from the first shaft member 12 as illustrated in FIG. 4. In addition, the portion of the first shaft member 12 located on one side (the negative direction of the Z axis in FIG. 4) from the second shaft member 13 is longer than the portion of the first shaft member 12 located on the other side (the positive direction of the Z axis in the example of FIG. 4) from the second shaft member 13.

The shaft fixing portion 14 is a member that fixes the second shaft member 13 to the first shaft member 12. The shaft fixing portion 14 may have any mechanism for fixing the second shaft member 13 to the first shaft member 12, and the second shaft member 13 may be fixed to the first shaft member 12 by any method.

The top board 15 is provided at an end portion of the first shaft member 12 on the side opposite to the side on which the base 11 is provided. In the example shown in FIG. 1, the top board 15 is a member on a flat plate having two circular surfaces facing opposite to each other, and one surface of the top board 15 is provided at the end portion of the first shaft member 12 on the side opposite to the side on which the base 11 is provided. The surface of the top board 15 may have any shape such as a polygon or an ellipse. In addition, the top board 15 may not have a surface, and may be any shape.

Further, each member included in the fixing device 1 is formed of a material having rigidity to a degree of deformation due to a reaction force when the vibrator 2 attached to the fixing device 1 vibrates an object A being a predetermined value or less. The predetermined value is a negligible degree of deformation in the vibration characteristics test of the object A.

### Configuration of Vibrator

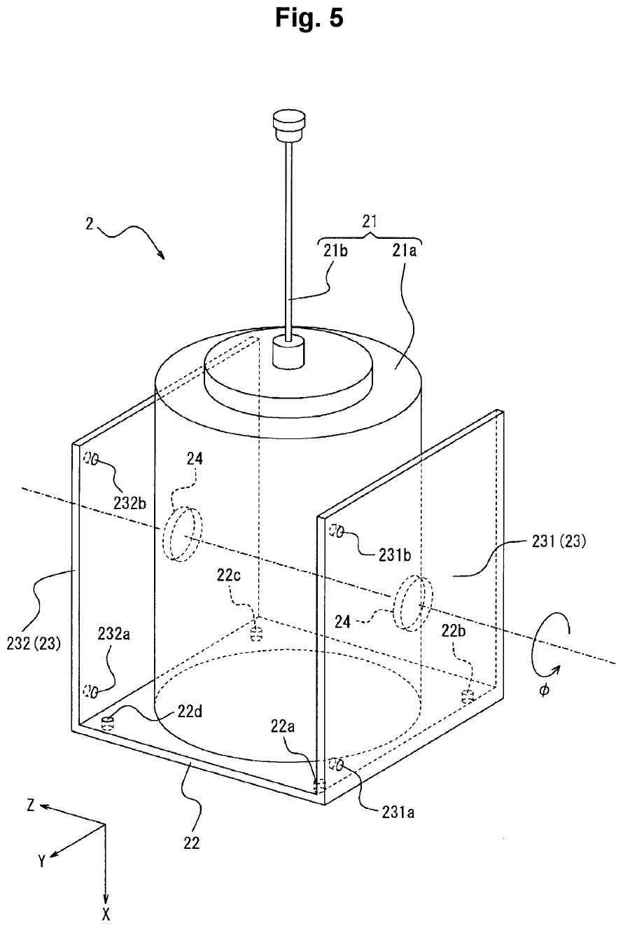

As illustrated in FIG. 5, the vibrator 2 includes a vibrator body 21, a first covering surface 22, and two second covering surfaces 23 (second covering surfaces 231 and 232). The vibrator 2 is attached to the second shaft member 13 of the fixing device 1. Specifically, the vibrator 2 is attached to the second shaft member 13 by suspending the attachment members 3 on the second shaft member 13. A specific aspect in which the attachment members 3 allow the vibrator 2 to be attached to the second shaft member 13 will be described in detail below.

The vibrator body 21 vibrates an object A. The vibrator body 21 includes a drive unit 21a and a stinger 21b. The drive unit 21a generates vibration. The stinger 21b is a needle-shaped member held by the drive unit 21a with a screw or the like. The stinger 21b is driven by the drive unit 21a to vibrate in a vibration direction, thereby vibrating the object A in contact with the tip of the stinger 21b. The vibration direction is a direction from the portion of the stinger 21b attached to the drive unit 21a to the tip of the stinger.

The first covering surface 22 is a planar member covering a surface (bottom surface) of the vibrator body 21 on the side opposite to the vibration direction. Specifically, the first covering surface 22 is a planar member that is disposed on the side of the vibrator body 21 on which the stinger 21b is not attached and that is orthogonal to the vibration direction. The first covering surface 22 may have a hole penetrating the first covering surface 22. In the example illustrated in FIG. 5, the first covering surface 22 has four holes 22a, 22b, 22c, and 22d. Furthermore, the planar shape of the first covering surface 22 is rectangular, and four holes 22a, 22b, 22c, and 22d are provided at each of the four corners of the rectangular shape.

The second covering surfaces 231 and 232 are planar members covering surfaces (side surfaces) of the vibrator body 21 parallel to the vibration direction. The second covering surfaces 231 and 232 face each other. Each of the second covering surfaces 231 and 232 may have a hole penetrating each of the second covering surfaces 231 and 232. In the example illustrated in FIG. 5, the second covering surface 231 has two holes 231a and 231b, and the second covering surface 232 has two holes 232a and 232b. Furthermore, the planar shape of the second covering surface 231 may be rectangular. In this configuration, the second covering surface 231 has the two holes 231a and 231b at each of two corners adjacent to each other in the vibration direction, and the second covering surface 232 has the two holes 232a and 232b at each of corners facing the holes 231a and 231b, respectively.

In addition, the vibrator 2 may further include a rotation shaft member 24.

The rotation shaft member 24 is a member configured such that the vibrator body 21 is rotatable about an axis (φ axis) extending in the normal direction of the two second covering surfaces 231 and 232 parallel to each other. The rotation shaft member 24 may be a member that is attached to the vibrator body 21, slides on the second covering surfaces 231 and 232, and rotates around the o axis together with the vibrator body 21. The rotation shaft member 24 may be a member attached on the side surfaces on the second covering surfaces 231 and 232 side and provided as to rotate around the o axis as the vibrator body 21 slides around the rotation shaft member 24.

Further, in the configuration in which the vibrator 2 includes the rotation shaft member 24, the first covering surface 22 is a planar member covering a surface (bottom surface) of the vibrator body 21 on the side opposite to the vibration direction in a predetermined state (a state before the vibrator body 21 rotates). When the vibrator body 21 is rotated by 90 degrees around the o axis from the predetermined state, the first covering surface 22 covers a surface (side surface) of the vibrator body 21 parallel to the vibration direction, which is not covered by the second covering surfaces 231 and 232.

In addition, in the configuration in which the vibrator 2 includes the rotation shaft member 24, the first covering surface 22 may have a hole, and the second covering surfaces 231 and 232 may have no holes. In addition, in the configuration in which the vibrator 2 includes the rotation shaft member 24, the first covering surface 22 may have no holes, and the second covering surfaces 231 and 232 may have a hole.

### Configuration of Attachment Member

The attachment members 3 are members for attaching the vibrator 2 to the fixing device 1.

In one example, as illustrated in FIGS. 1 to 4, the attachment members 3 may be members attached to the vibrator 2 and suspended on the second shaft member 13 of the fixing device 1. The attachment members 3 can be a string-like elastic member. The attachment members 3 are attached to the first covering surface 22 through a hole penetrating the first covering surface 22, or attached to the second covering surface 23 through a hole penetrating the second covering surface 23.

Specifically, when the vibrator 2 vibrates the object A from above, the attachment members 3 are attached to the first covering surface 22 via a hole of the first covering surface 22. Specifically, one attachment member 3 is attached to the first covering surface 22 by both end portions thereof passing through two holes (in the example of FIG. 5, holes 22a and 22b) and being fixed to the first covering surface 22. In addition, the other attachment member 3 is attached to the first covering surface 22 by both end portions thereof passing through two holes (in the example of FIG. 5, the holes 22c and 22d) and being fixed to the first covering surface 22. The attachment members 3 whose end portions are fixed to the first covering surface 22 in this manner are suspended on the second shaft member 13 such that the stinger 21b of the vibrator 2 abuts on the upper portion of the object A.

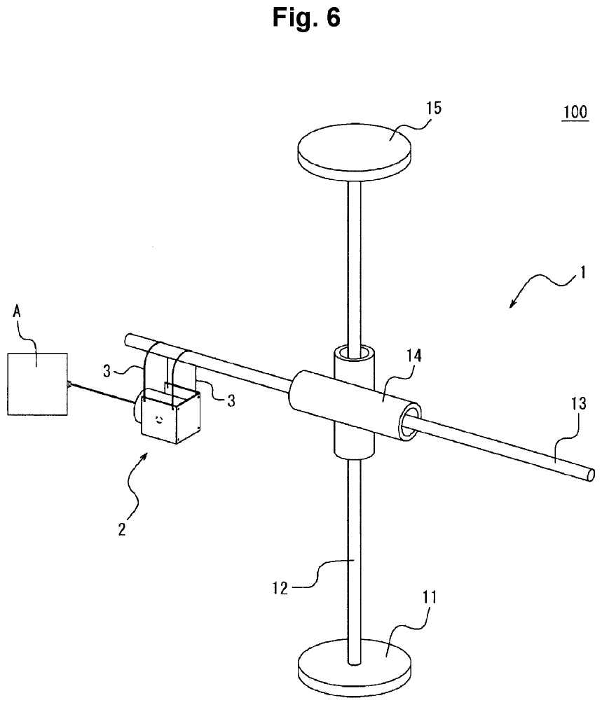

In addition, when the vibrator 2 vibrates the object A from a side, one attachment member 3 is attached to the two second covering surfaces 23 by both end portions thereof passing through the holes (the holes 231a and the holes 232a in FIG. 5) of the second covering surfaces 231 and 232, respectively, to be fixed as illustrated in FIG. 6. In addition, the other attachment member 3 is attached to the second covering surfaces 231 and 232 by both end portions thereof passing through the holes (the holes 231b and 232b in FIG. 5) of the two second covering surfaces 23, respectively, to be fixed to the second covering surfaces 23. The attachment members 3 whose end portions are fixed to the second covering surfaces 231 and 232 in this manner are suspended on the second shaft member 13 such that the stinger 21b of the vibrator 2 abuts on the side portion of the object A.

The attachment member 3 may be formed of an elastic material. As a result, it is possible to prevent the frequency of the vibration applied to the object A from being changed from the frequency of the vibration generated by the vibrator 2. In addition, the end portions of the attachment member 3 may be attached to the first covering surface 22 or the second covering surfaces 231 and 232 via an S-shaped hook or the like passing through the holes, instead of passing through the holes as described above.

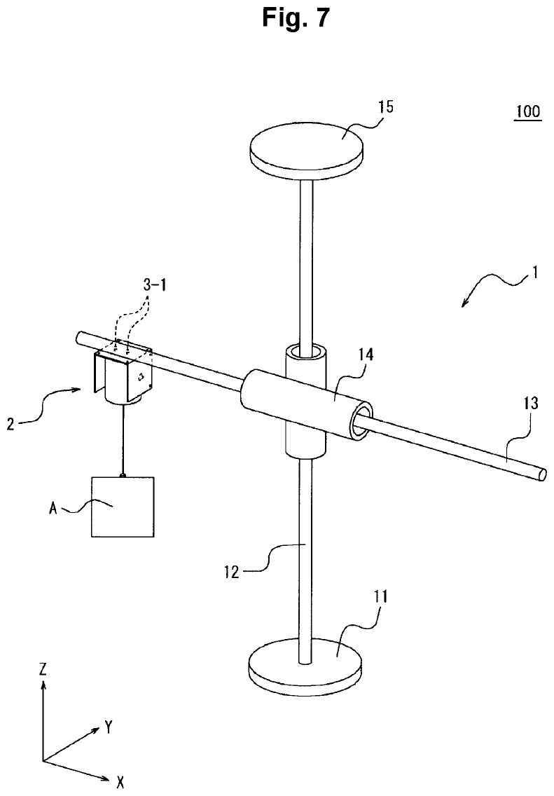

In addition, in another example, the fixing device 1 may include an attachment member 3-1, instead of the attachment members 3. The attachment member 3-1 may be a rigid member that rigidly connects the vibrator 2 to the second shaft member 13. The rigid member may be a screw, a pin, or the like. Specifically, when the vibrator 2 vibrates the object A from above, the attachment member 3-1 rigidly connects the first covering surface 22 to the lower side of the second shaft member 13 as illustrated in FIG. 7. In addition, when the vibrator 2 vibrates the object A from below, the attachment member 3-1 rigidly connects the first covering surface 22 to the upper side of the second shaft member 13. In addition, when the vibrator 2 vibrates the object A from a side, the attachment member 3-1 rigidly connects the first covering surface 22 to the second shaft member 13.

Furthermore, as described above, the vibrator 2 may include the rotation shaft member 24, and in that configuration, the attachment member 3 may be attached to the first covering surface 22 via the holes of the first covering surface 22 and suspended on the second shaft member 13 as illustrated in FIG. 1. In this case, the vibrator body 21 is rotated by the rotation shaft member 24 such that the direction from the vibrator 2 toward the object A is the vibration direction.

Furthermore, in the configuration in which the vibrator 2 includes the rotation shaft member 24 as described above, the attachment member 3 may be attached to the two second covering surfaces 23 via the holes respectively provided in the two second covering surfaces 23 as illustrated in FIG. 6. In this case, the vibrator body 21 is rotated by the rotation shaft member 24 such that the direction from the vibrator 2 toward the object A becomes the vibration direction.

As described above, the fixing device 1 according to the first embodiment includes the base 11, the first shaft member 12 provided on the base 11 and extending in the first direction, and the second shaft member 13 that is attached to the first shaft member 12, extends in the second direction orthogonal to the first direction, and is movable in the first direction and the second direction with respect to the first shaft member 12, the second shaft member 13 having the vibrator 2 attached thereto. As a result, the vibrator 2 can be installed to vibrate the attachment pipe 6 in both the vertical direction and the horizontal direction.

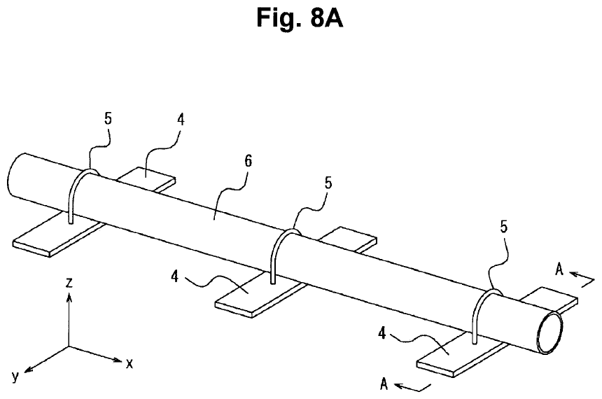

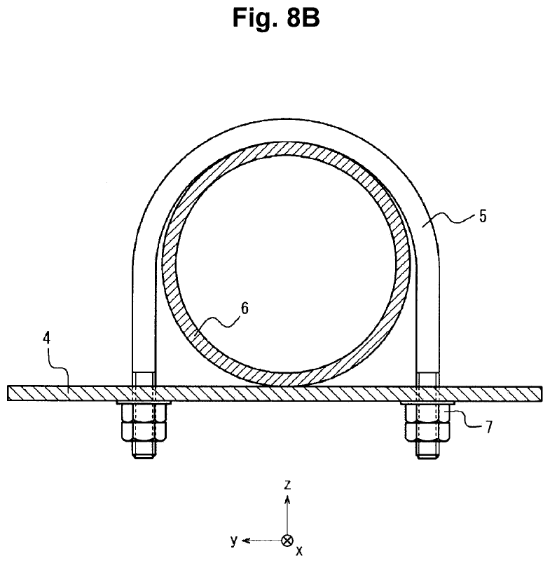

Here, the effect of a vibration characteristics test of an attachment pipe 6 installed on support bodies 4 installed on a bridge by U bolts 5 as illustrated in FIGS. 8A and 8B will be described in detail.

When the attachment pipe 6 is installed on the support bodies 4 by the U bolts 5 tightened by nuts 7 as illustrated in FIGS. 8A and 8B, the range of the attachment pipe 6 pressed by the U bolts 5 is a part. For this reason, the attachment pipe 6 easily moves in a direction (the y-axis direction in FIG. 8B) orthogonal to a press-hold direction (the negative direction of the z-axis in FIG. 8B) and the extending direction of the attachment pipe 6 (the x-axis direction in FIG. 8B) rather than the press-hold direction. That is, a response of the attachment pipe 6 to a vibration from the press-hold direction and a response of the attachment pipe 6 to a vibration from the orthogonal direction have different characteristics. Therefore, in order to recognize each of the different characteristics, it is necessary to vibrate the attachment pipe 6 from both the press-hold direction and the orthogonal direction in the vibration characteristics test. In the fixing device 1 of the first embodiment, since the second shaft member 13 is movable in the first direction and the second direction with respect to the first shaft member 12, the vibrator 2 can be installed so as to vibrate the attachment pipe 6 from the press-hold direction, and the vibrator 2 can also be installed so as to vibrate the attachment pipe 6 from the orthogonal direction. Vibration from the vibrator 2 installed in this manner makes it possible to sufficiently ascertain the response characteristics of the attachment pipe 6 and to perform a proper vibration characteristics test.

In addition, the attachment pipe 6 is restrained by the support bodies 4 due to the U bolts 5 fastened by the nuts 7 as illustrated in FIG. 8A. Therefore, the response of the attachment pipe 6 to a vibration from the press-hold direction and the response thereof to a vibration from the direction opposite to the press-hold direction (that is, a vibration from the support bodies 4) have different characteristics. Therefore, in the vibration characteristics test, in order to recognize each of the different characteristics, the attachment pipe 6 needs to receive a vibration from both the press-hold direction and the direction opposite to the press-hold direction. Here, in the fixing device 1 of the first embodiment, since the second shaft member 13 is movable in the first direction and the second direction with respect to the first shaft member 12, the vibrator 2 can be installed so as to vibrate the attachment pipe 6 from the press-hold direction, and the vibrator 2 can also be installed so as to vibrate the attachment pipe 6 from the direction opposite to the press-hold direction. Vibration from the vibrator 2 installed in this manner makes it possible to sufficiently ascertain the response characteristics of the attachment pipe 6 and to perform a proper vibration characteristics test.

In addition, the vibrating system 100 according to the first embodiment is a vibrating system 100 including a fixing device 1 and a vibrator 2 attached to the fixing device 1, in which the fixing device 1 includes the base 11, the first shaft member 12 provided on the base 11 and extending in the first direction, and the second shaft member 13 attached to the first shaft member 12, extending in the second direction orthogonal to the first direction, and movable in the first direction and the second direction with respect to the first shaft member 12, and the vibrator 2 is attached to the second shaft member 13. As a result, the object A can be vibrated by the vibrator 2 installed so as to be able to vibrate the attachment pipe 6 in both the vertical direction and the horizontal direction.

In addition, in the vibrating system 100 according to the first embodiment, the vibrator 2 includes the vibrator body 21 that vibrates the object A, the first covering surface 22 that covers the vibrator body 21 from the side opposite to the vibration direction, and the second covering surfaces 23 that cover the vibrator body 21 in the direction orthogonal to the vibration direction, and further includes the attachment members 3 that are attached to the first covering surface 22 through the holes penetrating the first covering surface 22 or attached to the second covering surfaces 23 through the holes penetrating the second covering surfaces 23, and the attachment members 3 are suspended from the second shaft member 13. Thus, the vibrator 2 can be easily attached to the fixing device 1 so that the vibrator 2 can vibrate the object A in the vertical direction, and the vibrator 2 can be easily attached to the fixing device 1 so that the object A can be vibrated in the horizontal direction.

In addition, the vibrating system 100 according to the first embodiment further includes the attachment member 3-1 that rigidly connects the vibrator 2 to the second shaft member 13. As a result, it is possible to prevent the frequency of the vibration applied to the object A from being changed from the frequency of the vibration generated by the vibrator 2. In addition, since the vibrating system 100 includes the attachment member 3-1, it is possible to suppress a reduction in a vibration force caused by a reaction force from the object A as compared with the case where the attachment members 3 are provided. Therefore, the vibrator 2 can reliably vibrate the object A at a frequency desired by the tester with a force in a desired magnitude.

Furthermore, since the attachment member 3-1 rigidly connects the vibrator 2 to the second shaft member 13, the vibrator 2 can be disposed such that the vibrator 2 vibrates the object A not only from above and from a side, but also from below. Therefore, the vibrating system 100 can vibrate the object A in more directions.

### Second Embodiment

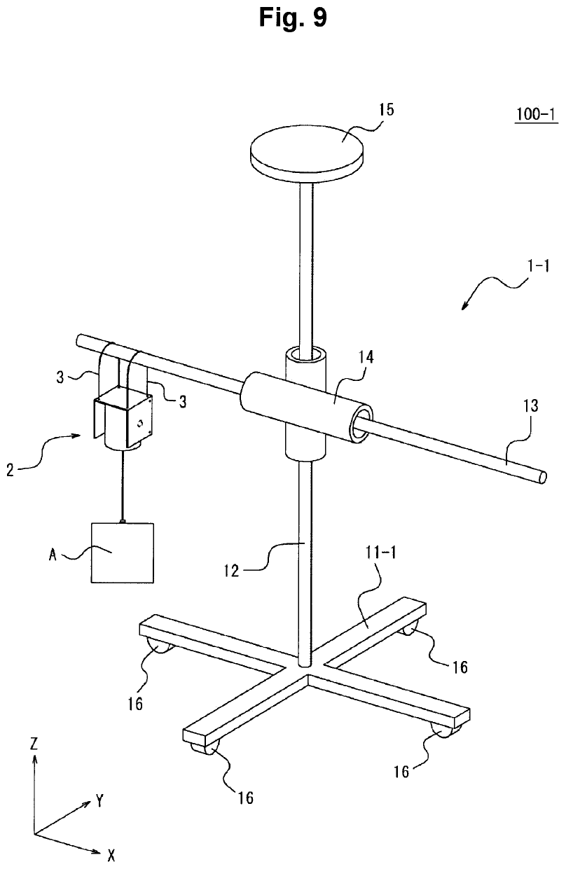

An overall configuration of a second embodiment will be described with reference to FIG. 9. FIG. 9 is a schematic diagram of a vibrating system 100-1 according to the second embodiment. In the second embodiment, the same functional parts as those in the first embodiment are denoted by the same reference numerals, and explanation thereof will be omitted.

As illustrated in FIG. 9, the vibrating system 100-1 according to the second embodiment includes a fixing device 1-1, a vibrator 2, and attachment members 3. In addition, the vibrating system 100-1 may include an attachment member 3-1, instead of the attachment member 3.

### Configuration of Fixing Device

The fixing device 1-1 may include a base 11-1, a first shaft member 12, a second shaft member 13, a shaft fixing portion 14 and casters 16. The fixing device 1-1 may further include a top board 15.

The base 11-1 is a base on which the first shaft member 12 is provided. In the example illustrated in FIG. 9, the base 11-1 is configured such that two prisms extending in directions orthogonal to each other intersect at the center of the prisms in the extending direction. However, the base 11-1 is not limited to the example illustrated in FIG. 9, and may have any shape.

The casters 16 are attached to the base 11-1 on the side opposite to the first shaft member 12. In the example illustrated in FIG. 9, the casters 16 are attached to both ends of each of the two prisms constituting the base 11 on the side opposite to the first shaft member 12. As a result, when the fixing device 1-1 is disposed such that the first shaft member 12 is positioned above the base 11-1, the casters 16 are positioned between the base 11-1 and the ground on which the base 11-1 is disposed. Furthermore, the casters 16 may have a stopper. The stopper is a member that stops rotation of a wheel-shaped member of the casters 16.

As described above, the fixing device 1-1 according to the second embodiment further includes the casters 16 attached to the base 11-1 on the side opposite to the first shaft member 12. Thus, the vibrator 2 attached to the fixing device 1-1 can vibrate the object A at an arbitrary position.

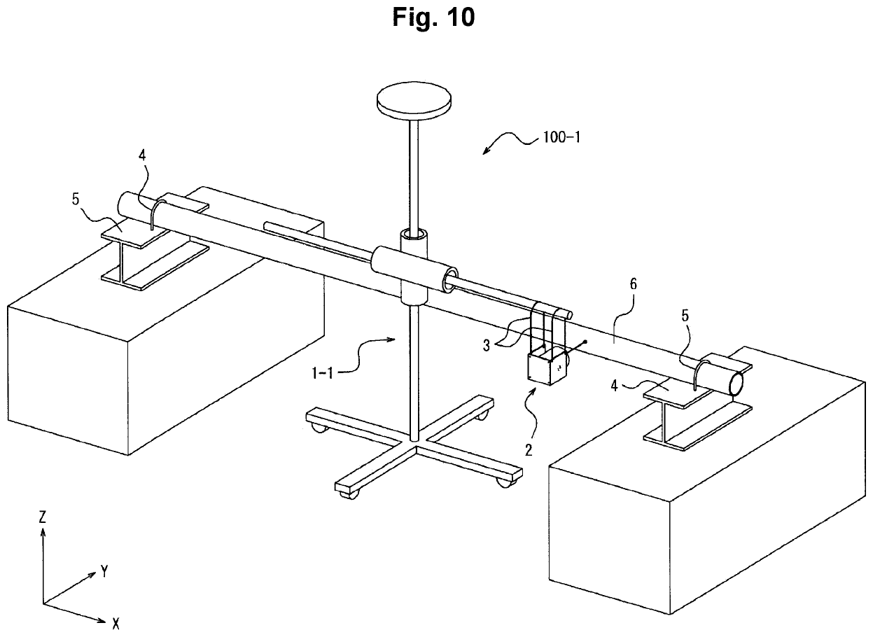

In addition, when the object A is an attachment pipe 6, the object A is restrained by the support bodies 4 with U bolts 5 at an interval of about 2.0 to 2.5 meters, and may extend longer than the length of the fixing device 1-1 in the second direction as illustrated in FIG. 10. Even in such a case, since the fixing device 1-1 is easily movable by including the casters 16, the arrangement of the vibrator 2 can be easily changed so that the vibrator 2 can vibrate the attachment pipe 6 in various portions. Therefore, the fixing device 1-1 enables to efficiently perform a vibration characteristics test of the attachment pipe 6 by using the vibrator 2.

As described above, in the fixing device 1-1 according to the second embodiment, the casters 16 may have a stopper. As a result, after the arrangement of the vibrator 2 is changed by moving the fixing device 1-1, the fixing device 1-1 can be reliably stopped by the stopper. As a result, it is possible to suppress a reduction in a vibration force by the vibrator 2 attached to the fixing device 1-1 caused by the reaction force.

Although the above-described embodiments have been described as typical examples, it is obvious to those skilled in the art that many modifications and substitutions can be made within the spirit and scope of the present disclosure. Thus, it should be understood that the present invention is not limited by the above-described embodiments, and various modifications or changes can be made without departing from the scope of the claims.

### REFERENCE SIGNS LIST

1, 1-1 Fixing device
2 Vibrator
3, 3-1 attachment member
4 Support body
5 U bolt
6 Attachment pipe
7 Nut
11, 11-1 Base
12 First shaft member
13 Second shaft member
14 Shaft fixing portion
15 Top board
16 Caster
21 Vibrator body
21a Drive unit
21b Stinger
22 First covering surface
22a, 22b, 22c, 22d Hole
23, 231, 232 Second covering surface
24 Rotation shaft member
100, 100-1 Vibrating system
231a, 231b Hole
232a, 232b Hole

1. A fixing device comprising:
a base;
a first shaft member provided on the base and extending in a first direction; and
a second shaft member that is attached to the first shaft member, extends in a second direction orthogonal to the first direction, and is movable in the first direction and the second direction with respect to the first shaft member, and to which the vibrator is attached.

2. The fixing device according to claim 1, further comprising: a caster attached to the base on a side opposite to the first shaft member.

3. The fixing device according to claim 2, wherein the caster has a stopper.

4. A vibrating system comprising:
a fixing device; and
a vibrator attached to the fixing device,
wherein the fixing device includes
a base,
a first shaft member provided on the base and extending in the first direction, and
a second shaft member that is attached to the first shaft member, extends in a second direction orthogonal to the first direction, and is movable in the first direction and the second direction with respect to the first shaft member, and to which the vibrator is attached.

5. The vibrating system according to claim 4,
wherein the vibrator includes
a vibrator body configured to vibrate an object,
a first covering surface that is a planar member covering a surface of the vibrator body on a side opposite to a vibration direction, and
a second covering surface that is a planar member covering a surface of the vibrator body that is parallel to the vibration direction.

6. The vibrating system according to claim 5, further comprising: an attachment member attached to the first covering surface through a hole penetrating the first covering surface or attached to the second covering surface through a hole penetrating the second covering surface,
wherein the vibrator is attached to the second shaft member by suspending the attachment member on the second shaft member.

7. The vibrating system according to claim 5, further comprising: an attachment member configured to rigidly connect the vibrator to the second shaft member.

8. The vibrating system according to claim 5, wherein the vibrator further includes a rotation shaft member configured such that the vibrator body is rotatable about an axis extending in a normal direction of the two second covering surfaces parallel to each other.
